(19) United States
(12) Patent Application Publication
(10) Pub. No.: US 2015/0087741 A1
(43) Pub. Date: Mar. 26, 2015

(54) PHOTO-CURING AND STRIPPABLE ADHESIVE COMPOSITION AND USES THEREOF

(71) Applicant: CHI MEI CORPORATION, TAINAN CITY (TW)

(72) Inventor: KUANG-CHIEH LI, TAINAN CITY (TW)

(21) Appl. No.: 14/486,713

(22) Filed: Sep. 15, 2014

(30) Foreign Application Priority Data
Sep. 25, 2013 (TW) 102134426

(51) Int. Cl. C09J 175/16; C09J 11/06

(52) U.S. Cl. CPC C09J 175/16; C09J 11/06; C08K 5/0041
USPC 522/75; 522/96; 522/78

(57) ABSTRACT

The invention relates to a photo-curing and strippable adhesive composition, and it has the advantages of good reworkability, weathering resistance, coating property and visibility. The invention also provides a strippable material and method for manufacturing the same and an electronic component and method for manufacturing the same.

### BACKGROUND OF THE INVENTION

1. Field of the Invention

The invention relates to a photo-curing and strippable adhesive composition, and it has the advantages of good reworkability, weathering resistance, coating property and visibility. The invention also provides a strippable material and method for manufacturing the same and an electronic component and method for manufacturing the same.

2. Description of the Related Art

Because of good adhesive properties and good maneuverability, pressure sensitive adhesives and adhesive sheets are widely used in the industry. In the field of electronic equipment, the pressure sensitive adhesives and adhesive sheets have been used in adhering various components. In order to achieving better stripability, various stripping agents are usually coated on a strippable substrate such as the adhesives and adhesive sheets.

As for the stripping agents, they are required to have stable stripability, and other properties are also required such as residual adhesive rate after using the stripping agents, reworkability, and coating property which can obtain a smoother surface.

The conventional stripping agents are divided into a thermoplastic resin type and a thermosetting resin type. The thermoplastic resin type has a problem of poor solvent resistance because no curing occurs after coating. On the other hand, although the solvent resistance is satisfactory of the thermosetting resin type, it has problems of thin thickness and poor thermo resistance because of thermo curing occurs after coating.

Furthermore, one of the main resins of the thermosetting resin type uses a crosslinking agent such as melamine to cure an alkyd resin as disclosed in Japanese Patent Publication Nos. 2008-156498 and 2008-156499. Although high performance is achieved by the use of the crosslinking agent such as melamine for curing the alkyd resin, the curing level is usually too high to make a film become brittle. In addition, the coating film is prone to fracture when stripping the coating film and the reworkability is poor. In addition, the use of the resins also fails to meet the requirement of weathering resistance in this field.

Besides, because the curing film is colorless and almost transparent, there is no simple method to confirm if the coating and curing are completed, and the processing is poor.

Therefore, overcoming the problems of reworkability and weathering resistance and improving coating property and visibility at the same time to obtain a photo-curing and strippable adhesive material that meet the current requirements are the target in the field of the present invention.

### SUMMARY OF THE INVENTION

In the present invention, a specific compound having an ethylenically unsaturated group and pigment dispersant are provided to obtain a photo-curing and strippable adhesive composition with good reworkability, weathering resistance, coating property and visibility.

Therefore, the present invention provides a photo-curing and strippable adhesive composition comprising:
a polyurethane acrylate oligomer (A);
a compound (B) having an ethylenically unsaturated group;
a photoinitiator (C); and
a pigment dispersant (D);
wherein:
the compound (B) having the ethylenically unsaturated group comprises a compound (B-1) represented by Formula (1),

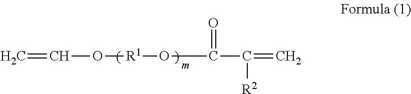

in Formula (1), R¹ represents a C₂ to C₈ divalent hydrocarbon group; R² represents hydrogen, or a methyl group; m represents an integer from 1 to 20; when m is an integer more than 2, a plurality of R¹ is the same or different.

The present invention also provides a method for manufacturing a strippable material comprising coating the photo-curing and strippable adhesive composition as mentioned above on a substrate.

The present invention also provides a strippable material, which is obtained by the method as mentioned above.

The present invention further provides an electronic device, comprising the strippable material as mentioned above.

The present invention further provides a method for manufacturing an electronic device, wherein the electronic device comprising a strippable material, wherein the strippable material is provided by the method as mentioned above.

### DETAILED DESCRIPTION OF THE INVENTION

The invention relates to a photo-curing and strippable adhesive composition comprising:
a polyurethane acrylate oligomer (A);
a compound (B) having an ethylenically unsaturated group;
a photoinitiator (C); and
a pigment dispersant (D);
wherein:
the compound (B) having the ethylenically unsaturated group comprises a compound (B-1) represented by Formula (1),

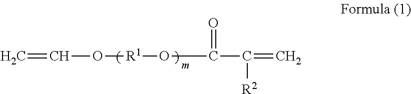

in Formula (1), R¹ represents a C₂ to C₈ divalent hydrocarbon group; R² represents hydrogen, or a methyl group; m represents an integer from 1 to 20; when m is an integer more than 2, a plurality of R¹ is the same or different.

The polyurethane acrylate oligomer (A) according to the invention comprises an aliphatic polyurethane acrylate oligomer (A-1) and/or an aromatic polyurethane acrylate oligomer (A-2).

According to the invention, examples of the aliphatic polyurethane acrylate oligomer (A-1) are bifunctional aliphatic polyurethane acrylate oligomer CN9002; bifunctional aliphatic polyurethane acrylate oligomer CN9004; bifunctional aliphatic polyurethane acrylate oligomer CN9005 (Tg=−10° C.); hexa-functional aliphatic polyurethane acrylate oligomer CN9006 (Tg=83° C.); bifunctional aliphatic polyurethane acrylate oligomer CN9007; bifunctional aliphatic polyurethane acrylate oligomer CN9178; bifunctional aliphatic polyurethane acrylate oligomer CN9290US, (Tg=−28° C.); bifunctional aliphatic polyurethane oligomer CN940; bifunctional aliphatic polyurethane oligomer CN9788; trifunctional aliphatic polyurethane acrylate oligomer CN989; bifunctional aliphatic polyurethane oligomer CN9893; polyurethane oligomer CN996; aliphatic polyurethane acrylate oligomer CN9009 (Tg=40° C.); aliphatic polyurethane acrylate oligomer CN9010 (Tg=103° C.); aliphatic polyurethane acrylate oligomer CN3211; aliphatic polyurethane acrylate oligomer CN9001 (Tg=60° C.); aliphatic polyurethane acrylate oligomer CN2920 (Tg=59° C.); aliphatic polyurethane oligomer CN9011; trifunctional aliphatic polyester polyurethane acrylate oligomer CN929 (Tg=17° C.); aliphatic polyester polyurethane diacrylate oligomer CN962 (Tg=−38° C.); aliphatic polyester polyurethane diacrylate oligomer CN965 (Tg=−37° C.); aliphatic polyester polyurethane diacrylate oligomer CN991; polyurethane acrylate oligomer CN980 (Tg=−29° C.); aliphatic polyester/polyether polyurethane diacrylate oligomer CN-981 (Tg=22° C.); aliphatic polyester polyurethane diacrylate oligomer CN964 (Tg=−24° C.); aliphatic polyester polyurethane hexaacrylate oligomer CN968 (Tg=34° C.); aliphatic polyester polyurethane diacrylate oligomer CN983; aliphatic polyester polyurethane diacrylate oligomer CN984; trifunctional aliphatic polyester polyurethane acrylate oligomer CN9008 (Tg=111° C.); aliphatic polyurethane acrylate CN9024; polyfunctional polyurethane acrylate oligomer CN9013 (Tg=143° C.); aliphatic polyurethane acrylate oligomer CN9014 (Tg=−41° C.) (all manufactured by Sartomer Inc.); and LAROMER UA19T, LAROMER UA 9028 V, LAROMER UA 9030V, LAROMER LR 8987, LAROMER UA 9029V, and LAROMER UA 9033V (all manufactured by BASF Inc.).

According to the invention, examples of the aromatic polyurethane acrylate oligomer (A-2) are aromatic polyurethane triacrylate oligomer CN2901 (Tg=35° C.); aromatic polyurethane triacrylate oligomer CN2902 (Tg=25° C.); bifunctional aromatic polyurethane triacrylate oligomer CN9782; bifunctional aromatic polyurethane triacrylate oligomer CN9783; aromatic polyester polyurethane diacrylate oligomer CN992; aromatic polyurethane acrylate oligomer CN994 (Tg=50° C.); low-viscosity aromatic polyurethane oligomer CN999 (Tg=97° C.); hexa-functional aromatic polyurethane acrylate oligomer CN997; brominated aromatic polyurethane acrylate oligonucleotide oligomer CN2600 (Tg=88.8° C.); brominated polyurethane acrylate oligomer containing 25% isobornyl acrylate CN902J75; hexa-functional aromatic polyurethane acrylate oligomer CN975 (Tg=−12° C.); aromatic polyether polyurethane diacrylate oligomer CN978 (Tg=−40° C.); aromatic polyether polyurethane triacrylate oligomer CN972 (Tg=−47° C.); polyurethane acrylate CN9022 (Tg=−16° C.) (all manufactured by Sartomer Inc.) and LAROMER UA 9031V (manufactured by BASF Inc.).

In the embodiment of the invention, the polyurethane acrylate oligomer (A) can contain a viscous liquid oligomer polymer with hundreds to thousands of weight average molecular weight. Preferably, the weight average molecular weight of the polyurethane acrylate oligomer (A) is from about 300 to about 5000; preferably from about 500 to about 3000; more preferably from about 700 to about 2000.

In one embodiment of the invention, a glass transition temperature of the polyurethane acrylate oligomer (A) is from about −80° C. to about 200° C.; preferably from about −60° C. to about 160° C.; more preferably form about −40° C. to about 120° C.

The compound (B) having the ethylenically unsaturated group comprises a compound (B-1) represented by Formula (1),

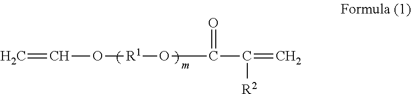

in Formula (1), R¹ represents a C₂ to C₈ divalent hydrocarbon group; R² represents hydrogen, or a methyl group; m represents an integer from 1 to 20; when m is an integer more than 2, a plurality of R¹ is the same or different.

In Formula (1), R¹ represents a C₂ to C₈ divalent hydrocarbon group, for example, an alkane diyl group such as ethylidene, a propane-1,2-diyl group, a propane-1,3-diyl group, a butane-1,4-diyl group, a pentane-1,5-diyl group, a hexane-1,6-diyl group, a heptane-1,7-diyl group, and an octane-1,8-diyl group; a cycloalkanediyl group such as a cyclohexane diyl group and a group represented by the following Formulae (* represents a bond). Preferred R¹ is ethylidene.

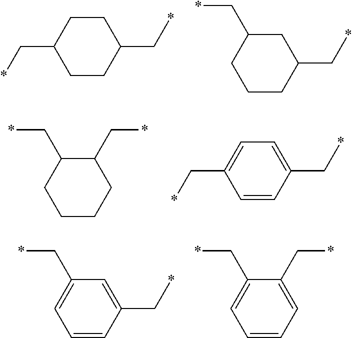

In Formula (1), m represents an integer from 1 to 20; preferably from 1 to 10; more preferably from 1 to 5, when m is an integer more than 2, a plurality of R¹ is the same or different.

The compound (B-1) represented by Formula (1) are, for example, (meth)acrylic acid 2-(2-vinyloxyethoxy)ethyl, (meth)acrylic acid 2-vinyloxyethyl, (meth)acrylic acid 3-vinyloxypropyl, (meth)acrylic acid 2-vinyloxypropyl, (meth)acrylic acid 1-vinyloxypropyl, (meth)acrylic acid 1-methyl-2-vinyloxyethyl, (meth)acrylic acid 4-vinyloxybutyl, (meth)acrylic acid 3-vinyloxybutyl, (meth)acrylic acid 2-vinyloxybutyl, (meth)acrylic acid 1-methyl-3-vinyloxypropyl, (meth)acrylic acid 2-methyl-3-vinyloxypropyl, (meth)acrylic acid 1-methyl-2-vinyloxypropyl, (meth)acrylic acid 1,1-dimethyl-2-vinyloxyethyl, (meth)acrylic acid 6-vinyloxyhexyl, (meth)acrylic acid 4-vinyloxycyclohexyl, (meth)acrylic acid (4-vinyloxymethylcyclohexyl)methyl, (meth)acrylic acid (3-vinyloxymethylcyclohexyl)methyl, (meth)acrylic acid (2-vinyloxymethylcyclohexyl)methyl, (meth)acrylic acid (4-vinyloxymethylphenyl)methyl, (meth)acrylic acid (3-vinyloxymethylphenyl)methyl, (meth)acrylic acid (2-vinyloxymethylphenyl)methyl, (meth)acrylic acid 2-(2-vinyloxyisopropoxy)ethyl, (meth)acrylic acid 2-(2-vinyloxyethoxy)propyl, (meth)acrylic acid 2-(2-vinyloxyisopropoxy)propyl, (meth)acrylic acid 2-(2-vinyloxyethoxy)isopropoxy, (meth)acrylic acid 2-(2-vinyloxyisopropoxy)isopropoxy, (meth)acrylic acid 2-(2-(2-vinyloxyethoxy)ethoxy)ethyl, (meth)acrylic acid 2-(2-(2-vinyloxyisopropoxy)ethoxy)ethyl, (meth)acrylic acid 2-(2-(2-vinyloxyisopropoxy)isopropoxy)ethyl, (meth)acrylic acid 2-(2-(2-vinyloxyethoxy)ethoxy)propyl, (meth)acrylic acid 2-(2-(2-vinyloxyethoxy)isopropoxy)propyl, (meth)acrylic acid 2-(2-(2-vinyloxyisopropoxy)ethoxy)propyl, (meth)acrylic acid 2-(2-(2-vinyloxyisopropoxy)isopropoxy)propyl, (meth)acrylic acid 2-(2-(2-vinyloxyethoxy)ethoxy)isopropyl, (meth)acrylic acid 2-(2-(2-vinyloxyethoxy)isopropoxy)isopropyl, (meth)acrylic acid 2-(2-(2-vinyloxyisopropoxy)ethoxy)isopropyl, (meth)acrylic acid 2-(2-(2-vinyloxyisopropoxy)isopropoxy)isopropyl, (meth)acrylic acid 2-(2-(2-(2-vinyloxyethoxy)ethoxy)ethoxy)ethyl, (meth)acrylic acid 2-(2-(2-(2-vinyloxyisopropoxy)ethoxy)ethoxy)ethyl, (meth)acrylic acid 2-(2-(2-(2-(2-vinyloxyethoxy)ethoxy)ethoxy)ethoxy)ethyl; wherein preferably is (meth)acrylic acid 2-vinyloxyethyl, (meth)acrylic acid 3-vinyloxyethyl, (meth)acrylic acid 2-vinyloxypropyl, (meth)acrylic acid 1-methyl-2-vinyloxyethyl, (meth)acrylic acid 4-vinyloxybutyl, (meth)acrylic acid 6-vinyloxyhexyl, (meth)acrylic acid 4-vinyloxycyclohexyl, (meth)acrylic acid 4-vinyloxymethylcyclohexyl)methyl, (meth)acrylic acid 2-(2-vinyloxyethoxy)ethyl, (meth)acrylic acid 2-(2-vinyloxyisopropoxy)propyl, (meth)acrylic acid 2-(2-(2-vinyloxyethoxy)ethoxy)ethyl; more preferably is (meth)acrylic acid 2-(2-vinyloxyethoxy)ethyl.

As used herein, the term “(meth)acrylic acid” refers to acrylic acid or methacrylic acid.

In the embodiment of the invention, based on 100 parts by weight of the used amount of the polyurethane acrylate oligomer (A), the used amount of the compound (B-1) is from 0.1 to 5 parts by weight; preferably from 0.1 to 4 parts by weight; more preferably from 0.2 to 3 parts by weight. If the compound (B-1) represented by Formula (1) is absent, the coating property is poor.

Preferably, the compound (B) having the ethylenically unsaturated group according to the invention further comprises a compound (B-2) selected from the group consisting of Formulae (2), (3) and (4),

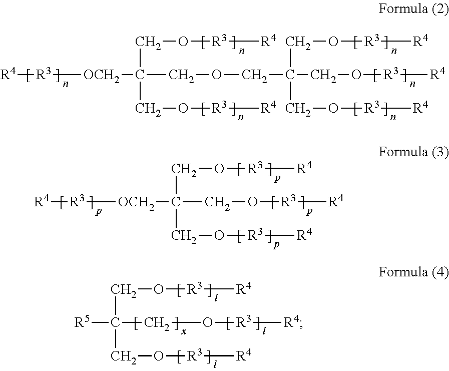

in Formulae (2) to (4),
R³ independently represents —(CH₂CH₂O)— or —(CH₂CH(CH₃)O)—;
R⁴ independently represents an acryloyl group, a methacryloyl group or hydrogen;
R⁵ independently represents hydrogen, a C₁ to C₆ alkyl group or an aryl group;
n independently represents an integer from 0 to 6, and a total number of n is 3 to 24; preferably, n independently represents an integer from 0 to 4, and a total number of n is preferably 6 or 12;
p independently represents an integer from 0 to 6, and a total number of p is 2 to 16; preferably, p independently represents an integer from 0 to 4, and a total number of p is preferably 4 or 8;
l independently represents an integer of 0 to 10, and a total number of l is 3 to 30; and
x represents an integer from 0 to 3; and
in Formula (2), a total number of the acryloyl group and methacryloyl group is 5 or 6;
in Formula (3), a total number of the acryloyl group and methacryloyl group is 3 or 4; and
in Formula (4), a total number of the acryloyl group and methacryloyl group is 3.

Preferably, in Formula (2), (3) or (4), —(CH₂CH₂O)— or —(CH₂CH(CH₃)O)— of R³ links to R⁴ through the terminal of the oxygen side.

The structure of the compound (B-2) can be a combination of two or more compounds of the Formula (2), (3) or (4). Preferably, in Formula (5), six R⁴s are all the acryloyl group.

The compound represented by Formula (2) or (3) can be synthesized according to a conventional method as follows: carrying on a ring-opening addition reaction of pentaerythritol or dipentaerythritol with ethylene oxide or propylene oxide to link a ring-opened frame; and introducing a (meth)acryloyl group by reacting (meth)acryloyl chloride and a terminal hydroxyl group of the ring-opened frame. The steps of the method are well known. Artisans skilled in the field of the present invention are able to synthesize the compound represented by Formula (2) or (3).

Preferably, the compound represented by Formula (2) or (3) is pentaerythritol derivatives and/or dipentaerythritol derivatives.

Examples of the compound represented by Formula (2) are compounds represented by Formulae (a) to (d); wherein a total number of n in Formulae (a) and (d) is 6; a total number of n in Formulae (b) and (c) is 12. Preferably, the compound represented by Formula (2) is compounds represented by Formulae (a) and (b). Commercial products are also available such as KAYARAD DPEA-12 (manufactured by Nippon Kayaku Co., Ltd.).

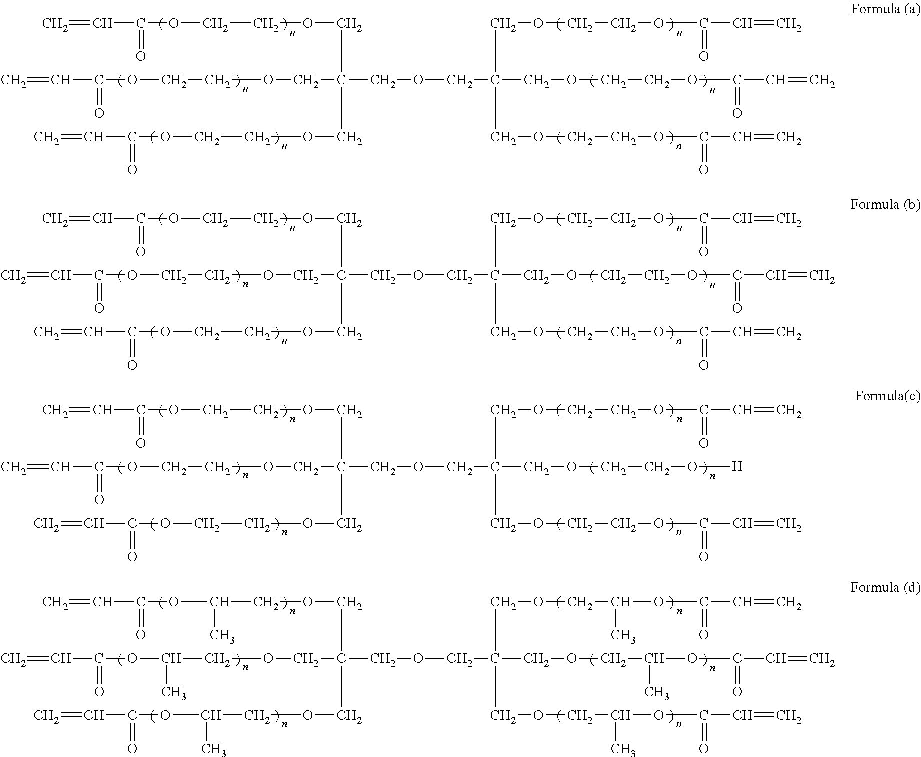

Examples of the compound represented by Formula (3) are compounds represented by Formulae (e) to (f), ethoxylated pentaerythritol tetraacrylate or propoxylated pentaerythritol tetraacrylate; wherein a total number of p in Formula (e) is 4; a total number of p in Formula (f) is 12. Commercial products are also available such as EM2411, EM2421 (both manufactured by Eternal Chemical Industries, Ltd.), Miramer M4004 (manufactured by TOYO KAGAKU, INC.).

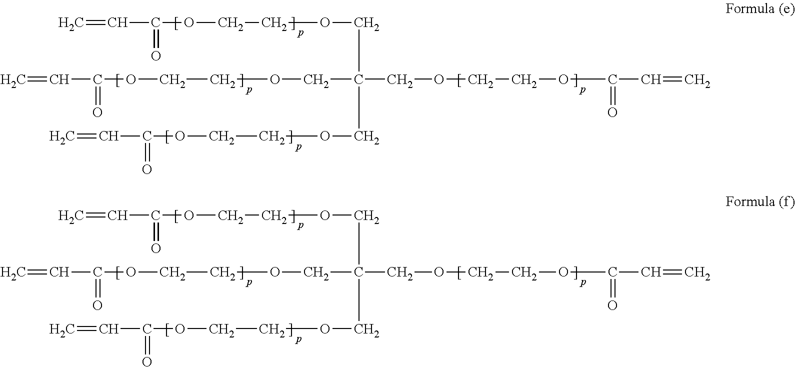

Examples of the compound represented by Formula (4) are ethoxylated trimethylolpropane triacrylate, ethoxylated trimethylolpropane trimethacrylate, propoxylated trimethylolpropane triacrylate, and propoxylated glyceryl triacrylate. Commercial products are also available such as KAYARAD GPO-303, KAYARAD THE-330, KAYARAD TPA-320, KAYARAD TPA-330 (all manufactured by Nippon Kayaku Co., Ltd.), M-310, M-321, M-350, M-360, M-460 (all manufactured by Toa Gosei Co., Ltd.), SR415, SR454, SR492, SR499, CD501, SR502, SR9020, SR9021, SR9035 (all manufactured by Sartomer Inc.), EM2380, EM2381, EM2382, EM2383, EM2384, EM2385, EM2386, EM2387, EM3380 (all manufactured by Eternal Chemical Industries, Ltd.), Miramer M3130, Miramer M3160, Miramer M3190, Miramer M360 (all manufactured by TOYO KAGAKU, INC.).

If the compound having the ethylenically unsaturated group (B-2) selected from the group consisting of Formulae (2), (3) and (4) is used, the weathering resistance is better.

In the embodiment of the invention, based on 100 parts by weight of the used amount of the polyurethane acrylate oligomer (A), the used amount of the compound (B-2) is from 0.5 to 10 parts by weight; preferably from 0.8 to 8 parts by weight; more preferably from 1 to 6 parts by weight.

The compound (B) having the ethylenically unsaturated group according to the invention further comprises an other compound (B-3). The other compound (B-3) according to the present invention comprises but is not limited to a first compound, a second compound, or a combination thereof.

The first compound according to the invention is a (meth)acrylate compound obtained by reacting a caprolactone-modified polyol with a (meth)acrylic acid.

The caprolactone-modified polyol according to the invention is obtained by reacting a caprolactone with a polyol having more than 4 functional groups, wherein the caprolactone can be γ-caprolactone, δ-caprolactone or ε-caprolactone; preferably is ε-caprolactone. The aforesaid polyol having more than 4 functional groups can be pentaerythritol, ditrimethylolpropane, dipentaerythritol and the like. The used amount of the caprolactone is preferably 1 to 12 mol based on the 1 mole of the used amount of the polyol having more than 4 functional groups.

Examples of the first compound are pentaerythritol caprolactone-modified tetra(meth)acrylate, ditrimethylolpropane caprolactone-modified tetra(meth)acrylate, and dipentaerythritol caprolactone-modified poly(meth)acrylate. The aforesaid dipentaerythritol caprolactone-modified poly(meth)acrylate can be dipentaerythritol caprolactone-modified di(meth)acrylate, dipentaerythritol caprolactone-modified tri(meth)acrylate, dipentaerythritol caprolactone-modified tetra(meth)acrylate, dipentaerythritol caprolactone-modified penta(meth)acrylate, and dipentaerythritol caprolactone-modified hexa(meth)acrylate.

Furthermore, the structure of dipentaerythritol caprolactone-modified poly(meth)acrylate is represented by Formula (5):

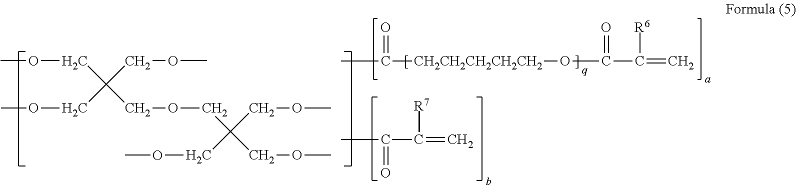

in Formula (5):
R⁶ and R⁷ each represent hydrogen or a methyl group;
q is an integer from 1 to 2;
a is an integer of 1 to 6;
b is an integer of 0 to 5;
wherein a+b=2 to 6; preferably a+b=3 to 6; more preferably a+b=5 to 6, and most preferably a+b=6.

More particularly, the first compound is KAYARAD® DPCA-20, DPCA-30, DPCA-60, DPCA-120 manufactured by Nippon Kayaku Co., Ltd.

The second compound comprises a functional group represented by Formula (6),

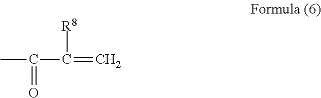

wherein, R⁸ represents hydrogen or a methyl group.

Examples of the second compound are acrylamide, (meth)acryloylmorpholine, 7-amino-3,7-dimethyloctyl(meth)acrylate, iso-butoxymethyl(meth)acrylamide, iso-bornyloxyethyl(meth)acrylate, iso-bornyl(meth)acrylate, 2-ethylhexyl(meth)acrylate, ethyl diethylene glycol(meth)acrylate, t-octyl(meth)acrylamide, diacetone(meth)acrylamide, dimethylaminoethyl(meth)acrylate, dodecyl(meth)acrylate, dicyclopentenyloxyethyl(meth)acrylate, dicyclopentenyl(meth)acrylate, N, N-dimethyl(meth)acrylamide, tetrachlorophenyl(meth)acrylate, 2-tetrachlorophenoxy ethyl(meth)acrylate, tetrahydrofurfuryl(meth)acrylate, tetrabromophenyl(meth)acrylate, 2-tetrabromophenoxyethyl(meth)acrylate, 2-trichlorophenoxyethyl(meth)acrylate, tribromophenyl(meth)acrylate, 2-tribromophenoxyethyl(meth)acrylate, 2-hydroxyethyl(meth)acrylate, 2-hydroxypropyl(meth)acrylate, vinylcaprolactam, N-vinylpyrrolidone, phenoxyethyl(meth)acrylate, pentachlorophenyl(meth)acrylate, pentabromophenyl(meth)acrylate, polyethylene glycol mono(meth)acrylate, polypropylene glycol mono(meth)acrylate, bornyl(meth)acrylate, ethylene glycol di(meth)acrylate, dicyclopentenyl di(meth)acrylate, triethylene glycol diacrylate, tetraethylene glycol di(meth)acrylate, tri(2-hydroxyethyl) isocyanate di(meth)acrylate, tri(2-hydroxyethyl) isocyanate tri(meth)acrylate, caprolactone-modified tri(2-hydroxyethyl) isocyanate tri(meth)acrylate, trimethylolpropyl tri(meth)acrylate, ethylene oxide (hereinafter abbreviated as EO) modified trimethylolpropyl tri(meth)acrylate, propylene oxide (hereinafter abbreviated as PO) modified trimethylolpropyl tri(meth)acrylate, tripropylene glycol di(meth)acrylate, neopentyl glycol di(meth)acrylate, 1,4-butanediol di(meth)acrylate, 1,6-hexanediol di(meth)acrylate, pentaerythritol tri(meth)acrylate, pentaerythritol tetra(meth)acrylate, polyester di(meth)acrylate, polyethylene glycol di(meth)acrylate, dipentaerythritol hexa(meth)acrylate, dipentaerythritol penta(meth)acrylate, dipentaerythritol tetra(meth)acrylate, ditrimethylolpropyl tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, PO-modified glycerol triacrylate, EO-modified bisphenol F di(meth)acrylate, EO-modified dipentaerythritol hexaacrylate (commercial name: DPEA-12, manufactured by Nippon Kayaku Co., Ltd.), or phenol novolac polyglycidyl ether(meth)acrylate.

Preferably, the second compound is selected from the group consisting of trimethylolpropyl triacrylate, EO-modified trimethylolpropyl triacrylate, PO-modified trimethylolpropyl triacrylate, pentaerythritol triacrylate, pentaerythritol tetraacrylate, dipentaerythritol hexaacrylate, dipentaerythritol pentaacrylate, dipentaerythritol tetraacrylate, EO-modified dipentaerythritol hexaacrylate (commercial name: DPEA-12, manufactured by Nippon Kayaku Co., Ltd.), ditrimethylolpropyl tetra(meth)acrylate, PO-modified glycerol triacrylate, and TO-1382 (manufactured by Toa Gosei Co., Ltd.).

In one embodiment of the invention, based on 100 parts by weight of the used amount of the polyurethane acrylate oligomer (A), the used amount of the compound (B-3) is from 0.4 to 5 parts by weight; preferably from 0.6 to 4 parts by weight; more preferably from 0.8 to 3 parts by weight.

In one embodiment of the invention, based on 100 parts by weight of the used amount of the polyurethane acrylate oligomer (A), the used amount of the compound (B) is from 1 to 20 parts by weight; preferably from 1.5 to 16 parts by weight; more preferably from 2 to 12 parts by weight.

Examples of the photoinitiator (C) according to the invention are acetophenone, biimidazole, acyl oxime, or combinations thereof.

Examples of the acetophenone are p-dimethylamino acetophenone, α,α′-dimethoxyazoxy acetophenone, 2,2′-dimethyl-2-phenyl acetophenone, p-methoxy acetophenone, 2-methyl-1-(4-methylthiophenyl)-2-morpholino-1-propanone, or 2-benzyl-2-N,N-dimethylamino-1-(4-morpholinophenyl)-1-butanone.

Examples of the biimidazole are 2,2′-bis(o-chlorophenyl)-4,4′,5,5′-tetraphenyl biimidazole, 2,2′-bis(o-fluorophenyl)-4,4′,5,5′-tetraphenyl biimidazole, 2,2′-bis(o-methylphenyl)-4,4′,5,5′-tetraphenyl biimidazole, 2,2′-bis(o-methoxyphenyl)-4,4′,5,5′-tetraphenyl biimidazole, 2,2′-bis(o-ethylphenyl)-4,4′,5,5′-tetraphenyl biimidazole, 2,2′-bis(p-methoxyphenyl)-4,4′,5,5′-tetraphenyl biimidazole, 2,2′-bis(2,2′,4,4′-tetramethoxyphenyl)-4,4′,5,5′-tetraphenyl biimidazole, 2,2′-bis(2-chlorophenyl)-4,4′,5,5′-tetraphenyl biimidazole, or 2,2′-bis(2,4-dichlorophenyl)-4,4′,5,5′-tetraphenyl biimidazole.

Examples of the acyl oxime are ethanone,1-[9-ethyl-6-(2-methylbenzoyl)-9H-carbazole-3-yl]-,1-(O-acetyl oxime) (CGI-242, manufactured by Ciba Specialty Chemicals, as shown in Formula (7)), 1-(4-phenyl-thio-phenyl)-octane-1,2-dion 2-oxime-O-benzoate (CGI-124, manufactured by Ciba Specialty Chemicals, as shown in Formula (8)), or ethanone,1-[9-ethyl-6-(2-chloro-4-benzyl-thio-benzoyl)-9H-carbazole-3-yl]-,1-(O-acetyl oxime) (manufactured by Adeka Corporation, as shown in Formula (9)).

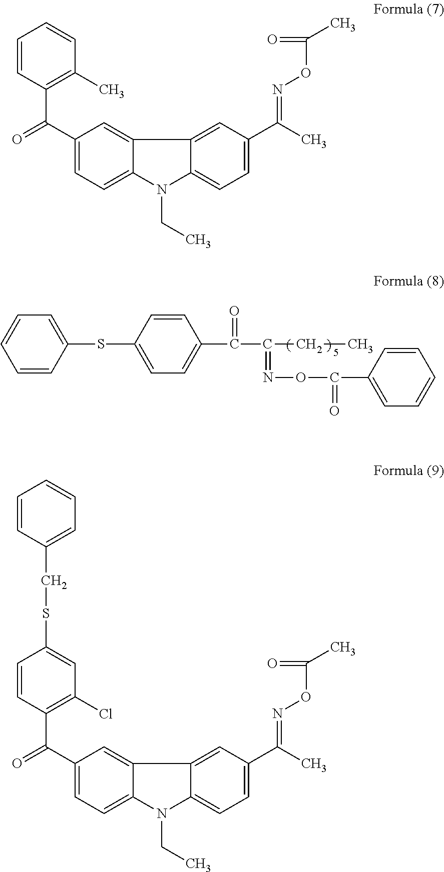

Preferably, the photoinitiator (C) is 2-methyl-1-(4-methylthiophenyl)-2-morpholino-1-propanone, 2-benzyl-2-N,N-dimethylamino-1-(4-morpholinophenyl)-1-butanone, 2,2′-bis(o-fluorophenyl)-4,4′,5,5′-tetraphenyl-biimidazole, ethanone,1-[9-ethyl-6-(2-methylbenzoyl)-9H-carbazole-3-yl]-,1-(O-acetyl oxime), or combinations thereof.

According to the invention, the photoinitiator (C) optionally further comprises: benzophenone such as thioxanthone, 2,4-diethyl-thioxanthanone, thioxanthone-4-sulfone, benzophenone, 4,4′-bis(dimethylamino)benzophenone, and 4,4′-bis(diethylamino)benzophenone; α-diketone such as benzyl, and acetyl; acyloin such as benzoin; acyloin ether such as benzoin methylether, benzoin ethylether, and benzoin isopropyl ether; acylphosphineoxide such as 2,4,6-trimethyl-benzoyl-diphenyl-phosphineoxide and bis-(2,6-dimethoxy-benzoyl)-2,4,4-trimethyl-benzyl-phosphineoxide; quinine such as anthraquinone and 1,4-naphthoquinone; halide such as phenacyl chloride, tribromomethyl-phenylsulfone and tris(trichloromethyl)-s-triazine; peroxide such as di-tertbutylperoxide; preferably are benzophenone; more preferably are 4,4′-bis(dimethylamino)benzophenone.

In one embodiment of the invention, based on 100 parts by weight of the used amount of the polyurethane acrylate oligomer (A), the used amount of the photoinitiator (C) is from 1 to 10 parts by weight; preferably is from 1.5 to 8 parts by weight; more preferably is form 2 to 6 parts by weight.

The pigment dispersant (D) according to the invention comprises an organic pigment (d-1), a polymeric monomer (d-2), and an adhesive resin (d-3).

The organic pigment (d-1) comprises triarylcarbonium, Cu phthalocyanine, metal free phthalocyanine, indanthrone or indigo.

Examples of the triarylcarbonium are Pigment Blue 1, Pigment Blue 2, Pigment Blue 9, Pigment Blue 10, Pigment Blue 14, Pigment Blue 18, Pigment Blue 19, Pigment Blue 56, Pigment Blue 62; examples of the Cu phthalocyanine are Pigment Blue 15, Pigment Blue 15:1, Pigment Blue 15:3, Pigment Blue 15:4, Pigment Blue 15:6; examples of the metal free phthalocyanine is Pigment Blue 16; examples of the indanthrone are Pigment Blue 60, Pigment Blue 64; examples of the indigo are Pigment Blue 66, Pigment Blue 63.

When the particle size of the organic pigment (d-1) is between 30 nm and 300 nm, the visibility is better. Therefore, the organic pigment (d-1) according to the invention which is preferably micronized. In one embodiment of the invention, the method of the micronizing includes plunging a clay-like mixture which is formed by blending at least the organic pigment (d-1), more than three times parts by weight of a water-soluble inorganic salt based on the organic pigment (d-1) and a water-soluble solvent into water. The mixture is highly kneaded for micronizing, and stirred in a high speed mixer to form a slurry. Then, the slurry is washed repeatedly and filtered to remove the water-soluble inorganic salt and water-soluble solvent. In the process of the micronizing, a resin or a dispersant can be added in.

The inorganic salt is, for example, sodium chloride, or potassium chloride. The water-soluble inorganic salt is more than 3 times parts by weight than the organic pigment (d-1); preferably less than 20 times parts by weight. When the water-soluble inorganic salt is less than 3 times parts by weight, it can not obtain the desired size of the pigment; when the water-soluble inorganic salt is more than 20 times parts by weight, it requires a lot of washing, and it reduces the substantive amount of the organic pigment in a treatment.

The water-soluble solvent provides an appropriate clay state for the inorganic salt and the organic pigment of a grinding aid, and helps the inorganic salt and the organic pigment to be sufficiently grinded. The kind of the water-soluble solvent is not particularly limited. Preferably it is easy to evaporate at a kneading temperature rising process, and based on safety, the boiling point is at 120° C. to 250° C. The water-soluble solvent is, for example, 2-(methoxymethoxy)ethanol, 2-butoxyethanol, 2-(isopentyloxy)ethanol, 2-(hexyloxy)ethanol, diethylene glycol, diethylene glycol monomethyl ether, diethylene glycol monoethyl ether, diethylene glycol monomethyl ether, triethylene glycol, triethylene glycol monomethyl ether, liquid polyethylene glycol, 1-methoxy-2-propanol, 1-ethoxy-2-propanol, dipropylene glycol, dipropylene glycol monomethyl ether, dipropylene glycol monoethyl ether, or low molecular weight polyethylene glycol.

In the invention, enhancing pigment dispersion can contribute to the preservation of stability; wherein, adding a dispersant is a preferred feasible way. The dispersant is, for example, a carboxylic acid ester having a hydroxyl group, a long chain polyamino amide and high molecular weight acid ester salt, a high molecular weight polycarboxylic acid salt, a long chain polyamino amide and polar acid ester salt, a high molecular weight unsaturated acid ester, a high molecular copolymer, a modified polyurethane, a modified polyacrylate, a polyether ester type anionic surfactant, a naphthalenesulfonic acid formalin condensate salt, an aromatic sulfonic acid formalin condensate salt, a polyoxyethylene alkyl phosphate ester, a polyoxyethylene nonylphenyl ether, and a stearylamine acetate.

Examples of the dispersant manufactured by BYK Chemie Co., Ltd. are “Anti-Terra-U (polyamide amine and phosphate ester salt)”, “Anti-Terra-203/204 (high molecular weight carboxylic acid salt)”, “Disperbyk-101 (polyamide amine and phosphate ester salt), 107 (carboxylic acid ester having a hydroxyl group), 110, 111 (the abovementioned copolymer having acidic groups), 130 (polyamine), 161, 162, 163, 164, 165, 166, 170 (the abovementioned copolymer are high molecular copolymer)”, “400”, “Bykumen (high molecular weight unsaturated acid ester)”, “BYK-P104, P105 (high molecular weight unsaturated acid polycarboxylic acid), “P104S, 240S (high molecular weight unsaturated acid polycarboxylic silicon)”, “Lactimon (long chain amino unsaturated acid polycarboxylic silicon)”. Besides, examples of the dispersant manufactured by Efka CHEMICALS Co., Ltd. are “EFKA 44, 46, 47, 48, 49, 54, 63, 64, 65, 66, 71, 701, 764, 766”, “Efkapolymer 100 (modified polyacrylate), 150 (aliphatic modified polymer), 400, 401, 402, 403, 450, 451, 452, 453 (modified polyacrylate), 745 (Cu phthalocyanine)”; manufacturing by Kyoeisha Chemical Co., Ltd. are “Flowlen TG-710 (polyurethane oligomers)”, “Furonon SH-290, SP-1000”, “Pofuro No. 50E, No. 300 (acrylic copolymer)”; manufacturing by Kusumoto Kasei Co., Ltd. are “Disparlon KS-860, 873SN, 874 (high molecular dispersant), #2150 (aliphatic polycarboxylic acid), #7004 (polyether ester)”; manufacturing by Kao Corp. are “Demol RN, N (naphthalenesulfonic acid formalin condensate sodium salt), MS, C, SN-B (aromatic sulfonic acid formalin condensate sodium salt), EP”, HOMOGENOL L-18 (polycarboxylic polymer), “EMULGEN 920, 930, 931, 935, 950, 985 (polyoxyethylene nonylphenyl ether)”, “ACETAMIN 24 (coconut amine acetate)”, “86 (stearylamine acetate)”; manufacturing by Avecia are “Solsperse 5000 (phthalocyanine ammonium salt), 13940 (polyester amine), 17000 (aliphatic amine), 24000GR, 32000, 33000, 39000, 41000, 53000”; manufacturing by Nikko Chemical Co., Ltd. are “Nikkor T106 (polyoxyethylene sorbitan monooleate), MYS-IEX (polyoxyethylene monostearate), Hexagline 4-0 (hexaglyceryl tetraoleate); manufacturing by Ajinomoto Fine-Techno Co., Ltd. are “AJISPER PB821, 822, 824”.

Further, for enhancing the pigment dispersion and improving the preservation of stability, the preferred dispersant is acid derivatives of the organic pigment (d-1).

In one embodiment of the invention, based on 100 parts by weight of the used amount of the pigment dispersant (D), the used amount of the organic pigment (d-1) is from 5 to 50 parts by weight; preferably form 8 to 45 parts by weight; more preferably from 10 to 40 parts by weight.

The polymeric monomer (d-2) comprises a monofunctional monomer having a cyclic structure and/or di-functional monomer.

The monofunctional monomer having the cyclic structure is, for example, cyclohexyl acrylate, tetrahydrofurfuryl acrylate, benzyl acrylate, methyl phenoxy ethyl acrylate, 4-tert-butyl cyclohexyl acrylate, caprolactone-modified tetrahydrofurfuryl acrylate, tribromophenyl acrylate, ethoxylated tribromophenyl acrylate, 2-phenoxyethylacrylate (or its epoxyethane and/or epoxypropane adduct monomer), acryloylmorpholine, isobornyl acrylate, phenoxy glycol acrylate, N-vinyl caprolactam, N-vinyl pyrrolidone, 2-hydroxy-3-phenoxypropyl acrylate, 1,4-cyclohexanedimethanol mono acrylate, N-acryloyloxyethylhexahydrophthalic imide.

The di-functional monomer is, for example, ethylene glycol di(meth)acrylate, dethylene glycol di(meth)acrylate, polyethylene glycol di(meth)acrylate, 1,6-hexanediol di(meth)acrylate, ethoxylated 1,6-hexanediol diacrylate, nopentyl glycol di(meth)acrylate, polypropylene glycol diacrylate, 1,4-butanediol di(meth)acrylate, 1,9-nonanediol diacrylate, tetraethylene glycol diacrylate, 2-n-butyl-2-ethyl-1,3-propanediol diacrylate, hydroxy acid neopentyl glycol diacrylate, 1,3-butylene glycol di(meth)acrylate, ethoxylated tripropylene glycol diacrylate, neopentyl glycol-modified trimethylolpropane diacrylate, stearic acid-modified pentaerythritol diacrylate, neopentyl glycol oligo acrylate, 1,4-butanediol oligo acrylate, 1,6-hexanediol oligo acrylate, ethoxylated neopentyl glycol di(meth)acrylate, propoxylated neopentyl glycol di(meth)acrylate, triethylene glycol di(meth)acrylate, bisphenol A diacrylate, dimethylol-tricyclodecane diacrylate, propoxylated bisphenol A di(meth)acrylate, ethoxylated bisphenol A di(meth)acrylate, bisphenol F diacrylate, ethoxylated bisphenol F diacrylate, propoxylated bisphenol F diacrylate, cyclohexanedimethanol di(meth)acrylate, dimethylol dicyclopentane diacrylate, isocyanurate diacrylate, propoxylated isocyanurate diacrylate. The compounds can be used solely or in combinations.

Preferably, the exampled polymeric monomer (d-2) is able to cross link to the compound (B) having the ethylenically unsaturated group.

In one embodiment of the invention, based on 100 parts by weight of the used amount of the pigment dispersant (D), the used amount of the polymeric monomer (d-2) is from 2 to 30 parts by weight; preferably form 3 to 18 parts by weight; more preferably from 4 to 16 parts by weight. When the polymeric monomer (d-2) is used, the reworkability is better.

The adhesive resin (d-3) can be polyvinyl chloride, poly(meth)acrylate, epoxy resin, polyurethane resin, cellulose derivatives (such as ethyl cellulose, cellulose acetate, nitro cellulose), polyvinyl chloride-vinyl acetate copolymer, polyamide resin, polyvinyl acetal resin, diallyl phthalate resin, butadiene-acrylonitrile copolymer, acrylic resin, styrene-acrylic acid resin, styrene-maleic acid resin, rosin resin, rosin ester resin, ethylene-vinyl acetate resin, petroleum resin, indene resin, terpene phenol resin, phenolic resin, melamine resin, urea resin, epoxy resin, cellulose resin, vinyl chloroacetate resin, xylene resin, alkyd resin, aliphatic hydrocarbon resin, butyral resin, silicone resin, maleic acid resin, fumaric acid resin. Examples of the adhesive resin (d-3) are Super Ester 75, ester gum HP, marukiddo33 manufactured by Arakawa Chemical Industries Ltd; YS Polystar T80 manufactured by Yasuhara, Inc.; Hiretts HRT 200X, Johnson Polymer, JONCRYL 586,611 manufactured by Mitsui Chemicals, Co., Ltd.; UCAR Solution Vinyl Resins VYHD, VYHH, YMCA manufactured by Dow Chemical Company. Wherein, the molecular weight of the adhesive resin (d-3) is from 1000 to 10000; preferably from 1000 to 5000. Moreover, the acid value of the adhesive resin (d-3) is from 50 to 150.

Furthermore, for making the low viscosity of the pigment dispersant and improving the wettability and diffusion property, the pigment dispersant (D) can comprise an organic solvent.

In one embodiment of the invention, based on 100 parts by weight of the used amount of the pigment dispersant (D), the used amount of the adhesive resin (d-3) is from 30 to 93 parts by weight; preferably form 40 to 90 parts by weight; more preferably from 50 to 80 parts by weight. When the adhesive resin (d-3) is used, the weathering resistance is better.

In one embodiment of the invention, the preparation of the pigment dispersant (D) is to put the organic pigment (d-1), the polymeric monomer (d-2) and the adhesive resin (d-3) into a high-speed mixer, stirred until homogeneous, and followed by a horizontal sand mill to obtain the pigment dispersant (D).

In one embodiment of the invention, based on 100 parts by weight of the used amount of the polyurethane acrylate oligomer (A), the used amount of the pigment dispersant (D) is from 2 to 20 parts by weight; preferably form 3 to 15 parts by weight; more preferably from 4 to 10 parts by weight. When the pigment dispersant (D) is absent, the visibility is poor.

Preferably, the photo-curing and strippable adhesive composition can further comprise an inorganic powder (E).

The kind of the inorganic powder (E) is not particularly limited, such as aluminum hydroxide, magnesium hydroxide, calcium carbonate, magnesium carbonate, calcium silicate, magnesium silicate, calcium oxide, magnesium oxide, aluminum oxide, aluminum nitride, aluminum borate whisker, boron nitride, crystalline silica, amorphous silica, and the aforemention can be used singly or in combination wherein preferably is aluminum oxide, aluminum nitride, boron nitride, crystalline silica, amorphous silica.

The average particle size of the inorganic powder (E) is not particularly limited, preferably from 0.005 μm to 5 μm. If the average particle size is from 0.005 μm to 5 μm, the adhesion is better. Furthermore, it also can use two or more kinds of the inorganic powder (E) with different sizes to adjust the used amount of the inorganic powder (E). The average particle size of the inorganic powder (E) is measured by a light scattering method.

In one embodiment of the invention, based on 100 parts by weight of the used amount of the polyurethane acrylate oligomer (A), the used amount of the inorganic powder (E) is from 2 to 20 parts by weight; preferably form 3 to 15 parts by weight; more preferably from 4 to 10 parts by weight. When the inorganic powder (E) is used, the reworkability is better.

Preferably, the photo-curing and strippable adhesive composition can further comprise a polyolefin wax (F).

According to the invention, the melting point of the polyolefin wax (F) is preferably more than 115° C.; more preferably from 115° C. to 160° C.

Examples of the polyolefin wax with the melting point more than 115° C. (hereafter as high melting-point polyolefin wax) are a polyolefin wax obtained by (co)polymerizing at least one olefin having a carbon number of 1 to 5 selected from the group consisting of ethylene, propylene, 1-butylene, and 4-methyl-1-pentylene; and a modified polyolefin wax obtained by modifying the above mentioned polyolefin wax by oxidation, acid modification and copolymerization with other ethylene monomer. The polyolefin wax can be used solely or in combinations. The melting point is measured according to a DSC method.

Examples of the polyolefin wax (F) are a polyethylene wax such as High Wax (trade name) 100P (melting point: 116° C.), High Wax 200P (melting point: 122° C.), High Wax 400P (melting point: 126° C.), High Wax 800P (melting point: 127° C.), High Wax 410P (melting point: 118° C.), High Wax 405MP (melting point: 121° C.), High Wax 4400G (melting point: 120° C.) (all manufactured by Mitsui Chemicals Co., Ltd.); Polyethylene (trade name) AC-8 (melting point: 116° C.), AC-8A (melting point: 116° C.), AC-9 (melting point: 119° C.), AC-9A (melting point: 119° C.), AC-316A (melting point: 140° C.), AC-325 (melting point: 137° C.), AC-330 (melting point: 137° C.), AC-392 (melting point: 138° C.) and AC-395 (melting point: 137° C.) (all manufactured by Allied Signal); POLYWAX (product name) 2000 (melting point: 126° C.) and POLYWAX 3000 (melting point: 126° C.) (both manufactured by PETROLITE Corporation); a polypropylene wax such as High Wax NP055 (melting point: 135° C. to 145° C.), High Wax NP105 (melting point: 140° C. to 148° C.) and High Wax NP805 (melting point: 145° C. to 152° C.). Other examples are EXCEREX 30200B (melting point: 102° C.), EXCEREX 30050B (melting point: 91° C.), EXCEREX 48070B (melting point: 90° C.), EXCEREX 15341PA (melting point: 89° C.) (all manufactured by Mitsui Chemicals Co., Ltd.), CERAFLOUR 913 (melting point: 160° C.), CERAFLOUR 914 (melting point: 160° C.), CERAFLOUR 915 (melting point: 160° C.), CERAFLOUR 928 (melting point: 115° C.), CERAFLOUR 970 (melting point: 160° C.), CERAFLOUR 988 (melting point: 140° C.) (all manufactured by BYK).

According to the present invention, the weight average molecular weight of the polyolefin wax (F) is from 5,000 to 100,000; preferably from 6,000 to 90,000; more preferably from 7,000 to 80,000.

In one embodiment of the invention, based on 100 parts by weight of the used amount of the polyurethane acrylate oligomer (A), the used amount of the polyolefin wax (F) is from 0.5 to 5 parts by weight; preferably form 0.6 to 4 parts by weight; more preferably from 0.7 to 3 parts by weight. If the polyolefin wax (F) is used, the reworkability is better.

The photo-curing and strippable adhesive composition according to the invention preferably further comprises an additive (G), such as a modifier, a defoaming agent, or an adhesive agent. Examples of the modifier are manganese naphthenate and the like and metal salts such as manganese octenate. Examples of the defoaming agent are silicone oil, fluorine oil, and polycarboxylic acid polymers.

In one preferred embodiment of the invention, a method for producing the photo-curing and strippable adhesive composition according to the invention comprises dispersing the aforementioned polyurethane acrylate oligomer (A), the compound having an ethylenically unsaturated group (B), the photoinitiator (C), the pigment dispersant (D), the optional inorganic powder (E), the polyolefin wax (F) and the additive (G) and heating to 50° C. and stirring for 1 to 48 hours in a mixer to dissolve the solids to form the photo-curing and strippable adhesive composition. In general, the viscosity of the photo-curing and strippable adhesive composition can be adjusted by artisans skilled in this field according to the coating property, volatility and other properties. When the viscosity of the photo-curing and strippable adhesive composition is 0.1 to 30 Pa·S, the strippable adhesive composition has a better coating property; preferably, the viscosity is 0.1 to 20 Pa·S; more preferably, 0.1 to 10 Pa·S.

The present invention also provides a method for manufacturing a strippable material comprising coating the strippable adhesive composition as mentioned above on a substrate. Preferably, the substrate is an electronic component.

According to the invention, the electronic component suitable for the treatment with the photo-curing and strippable adhesive composition includes but is not limited to a circuit board equipped with microprocessors, transistors, capacitors, resistors, relays, or transformers, wherein the circuit board has patterns of lead wires or wire harness in need of the treatment.

According to the present invention, the treatment of the electronic component with the photo-curing and strippable adhesive composition can be a known coating procedure, such as dipping, brush coating, spray coating, dispenser coating, and screen printing coating. In one preferred embodiment of the invention, the electronic component is further irradiated with UV light after coating to obtain the electronic device according to the invention.

The present invention also provides a strippable material, which is obtained by the method as mentioned above.

The present invention further provides an electronic device, comprising the strippable material as mentioned above.

The present invention further provides a method for producing an electronic device, comprising the method as mentioned above for providing a strippable material.

The following examples are given for the purpose of illustration only and are not intended to limit the scope of the present invention. The preparation of the pigment dispersant (D)

### Preparation Example (D-1)

The preparation of the pigment dispersant (D) was to put 5 parts by weight of the organic pigment (d-1-1); 2 parts by weight of the polymeric monomer (d-2-1); and 93 parts by weight of the adhesive resin (d-3-1) into a high-speed mixer, stirred until homogeneous, and followed by a horizontal sand mill for 1 hour to obtain the pigment dispersant (D-1).

### Preparation Examples (D-2) to (D-9)

The preparations are similar to that of Preparation Example (D-1) with modifications of the kinds and amounts of the organic pigment (d-1), the polymeric monomer (d-2), and the adhesive resin (d-3). The compositions and the results of the assays are shown in Table 1.

TABLE 1
Preparation Examples

| | | Components | | | | | | | | | | | |
|---|---|---|---|---|---|---|---|---|---|---|---|---|---|
| | | organic pigment | | | | | | | | adhesive resin | | | |
| | | (d-1) | | | polymeric monomer (d-2) | | | | | (d-3) | | | dispersion |
| | | (parts by weight) | | | (parts by weight) | | | | | (parts by weight) | | | time |
| Components | | d-1-1 | d-1-2 | d-1-3 | d-2-1 | d-2-2 | d-2-3 | d-2-4 | d-2-5 | d-3-1 | d-3-2 | d-3-3 | (hr) |
| pigment | D-1 | 5 | | | 2 | | | | | 93 | | | 1 |
| dispersant | D-2 | | 10 | | | 5 | | | | | 85 | | 0.8 |
| (D) | D-3 | | | 20 | | | 10 | | | | | 70 | 1 |
| | D-4 | 30 | | | | | | 20 | | | 20 | 30 | 1.2 |
| | D-5 | | 20 | 20 | 5 | | 10 | | | 45 | | | 1 |
| | D-6 | | | 50 | | 10 | | 10 | | | 30 | | 1 |
| | D-7 | 20 | | | | | | | 10 | 70 | | | 1 |
| | D-8 | | 15 | | | | | | | | 85 | | 1 |
| | D-9 | | | 40 | 60 | | | | | | | | 1 |

d-1-1 Pigment Blue 1
d-1-2 Pigment Blue 15:6
d-1-3 Pigment Blue 60
d-2-1 cyclohexyl acrylate
d-2-2 isobornyl acrylate
d-2-3 ethylene glycol diacrylate
d-2-4 tripropylene glycol diacrylate
d-2-5 methacrylate
d-3-1 Super Ester 75 (manufactured by Arakawa Chemical Industries Ltd)
d-3-2 Hiretts HRT 200X (manufactured by Mitsui Chemicals, Co., Ltd)
d-3-3 UCAR Solution Vinyl Resins VYHD (manufactured by Dow Chemical Company)

### Example 1

A four-necked flask was equipped with a stirrer, a heater and a thermometer, and the composition with the amount as shown in Table 2 are added. The composition comprised: 100 parts by weight of the aliphatic polyurethane acrylate oligomer (A-1-1); 2 part by weight of the compound represented by Formula (1) (B-1-1), 3 part by weight of the photoinitiator (C-1), and 2 parts by weight of the photoinitiator (C-3). Then, the temperature was raise to 50° C. and the composition was stirred for 1 hour. Subsequently, 2 parts by weight of the pigment dispersant (D-1) were added and the above temperature condition was maintained for stirring for 5 hours to obtain the photo-curing and strippable adhesive composition. The photo-curing and strippable adhesive composition was evaluated according to the following method, and the results are shown in Table 2.

### Examples 2 to 14 and Comparative Examples 1 to 6

The preparations are similar to that of Example 1 with modifications of the kinds and amounts of the aliphatic polyurethane acrylate oligomer (A), the compound having an ethylenically unsaturated group (B), the photoinitiator (C), the pigment dispersant (D), the optional inorganic powder (E), the polyolefin wax (F) and the additive (G). The compositions and the results of the assays are shown in Tables 2 and 3.

### Assays

### (a) Visibility:

The photo-curing and strippable adhesive composition was coated on a 100 mm×100 mm of rectangular glass substrate to form a 3 mm×100 mm of coating film with a dispenser machine (manufactured by Ever Sharp Technology Co., Ltd, ES-300SR). The film was irradiated with UV light (manufactured by Japan Battery Co., Ltd.) with the intensity of 120 mW/cm² and a total exposure amount of 1000 mJ//cm², and then the color of the coating film was observed. The criteria of the assay are shown blow:

◯: good (it can be instantly confirmed)

∘: bad (it can not be instantly confirmed)

(b) Coating property:

The photo-curing and strippable adhesive composition was coated on a 100 mm×100 mm of rectangular glass substrate to form an 80 mm×80 mm of coating film with a screen printing machine (manufactured by ATMA CHAMP ENT. Co., AT-45PA) and then the color of the coating film was observed. The criteria of the assay are shown blow:
⊚: After coating, the surface showed a flat shape, and no irregular lines appeared.
◯: After coating, the surface showed a flat shape, but a few irregular lines appeared.
Δ: After coating, the surface showed a flat shape, but serious irregular lines appeared.
∘: After coating, the surface showed an unflat shape, and serious irregular lines appeared.

### (c) Reworkability:

The photo-curing and strippable adhesive composition was coated on a 100 mm×100 mm of rectangular glass substrate to form a 3 mm×100 mm of coating film with a dispenser machine (manufactured by Ever Sharp Technology Co., Ltd, ES-300SR). The film was irradiated with UV light and then quickly pulled at a speed of 10 cm/s in the direction perpendicular to the substrate. The criteria of the assay are shown blow:

⊚: The film was completely pulled without fracture, and no residual film stayed on the substrate.

◯: The film was completely pulled without fracture, and few residual film stayed on the substrate.

Δ: The film was pulled without fracture, and a large amount of residual film stayed on the substrate.

∘: The film was pulled with fracture, and a large amount of residual film stayed on the substrate.

### (d) Weathering Resistance

The photo-curing and strippable adhesive composition was coated on a 100 mm×100 mm of rectangular glass substrate to form a 3 mm×100 mm of coating film with a dispenser machine (manufactured by Ever Sharp Technology Co., Ltd, ES-300SR). The film was irradiated with UV light and stayed in a chamber (Terchy system, model MHE-408RL) at 40° C. and 90% humidity for 20 hours. Then, the film was quickly pulled at a speed of 10 cm/s in the direction perpendicular to the substrate. The criteria of the assay are shown blow:

⊚: The film was completely pulled without fracture, and no residual film stayed on the substrate.

◯: The film was completely pulled without fracture, and few residual film stayed on the substrate.

Δ: The film was pulled without fracture, and a large amount of residual film stayed on the substrate

∘: The film was pulled with fracture, and a large amount of residual film stayed on the substrate

TABLE 2
Examples

| | | | Examples | | | | | | | | | | | | | |
|---|---|---|---|---|---|---|---|---|---|---|---|---|---|---|---|---|
| Components | | | 1 | 2 | 3 | 4 | 5 | 6 | 7 | 8 | 9 | 10 | 11 | 12 | 13 | 14 |
| polyurethane | aliphatic polyurethane | A-1-1 | 100 | | | | | | 100 | | | 30 | | | 50 | |
| acrylate oligomer | acrylate oligomer (A-1) | A-1-2 | | 100 | | | | | | 100 | | | 50 | | 50 | |
| (A) | | A-1-3 | | | 100 | | | | | | 100 | | | 70 | | |
| (parts by weight) | aromatic polyurethane | A-2-1 | | | | 100 | | | | | | 70 | | | | 50 |
| | acrylate oligomer (A-2) | A-2-2 | | | | | 100 | | | | | | 50 | | | 50 |
| | | A-2-3 | | | | | | 100 | | | | | | 30 | | |
| compound (B) | compound (B-1) | B-1-1 | 2 | | | | 5 | | 2 | | | | | 1 | 2 | |
| having an | represented by Formula | B-1-2 | | 1 | | | | 4 | | 1 | | | | 4 | | |
| ethylenically | (1) | B-1-3 | | | 0.5 | | | | | | 0.5 | 3 | 3 | | | |
| unsaturated group | | B-1-4 | | | | 0.1 | | | | | | | 2 | | | 0.1 |
| (parts by weight) | compound (B-2) | B-2-1 | | | | | 0.5 | | | | | 5 | | | | |
| | represented by Formulae | B-2-2 | | | | | | 5 | | | | | | | | |
| | (2), (3), or (4) | B-2-3 | | | | | | | | | | 5 | | | | |
| | other compound (B-3) | B-3-1 | | | | 1 | | | | | | | 2 | | | 1 |
| | having an ethylenically | B-3-2 | | | 0.5 | | | | | | | 7 | | | | |
| | unsaturated group | | | | | | | | | | | | | | | |

| | | | | | | | | | | | | | | | |
|---|---|---|---|---|---|---|---|---|---|---|---|---|---|---|---|
| photoinitiator (C) | C-1 | 3 | | 1 | | 6 | 7 | | 2 | 2 | | 3 | | 2 | 1 |
| (parts by weight) | C-2 | | 2 | | 0.5 | | | 3 | | | 7 | 3 | 5 | | 1 |
| | C-3 | 2 | | 1 | | 2 | | | 1 | | | 2 | 2 | 2 | |
| | C-4 | | 1 | | 0.5 | | 2 | 1 | | 2 | 3 | | 3 | 1 | 1 |
| pigment dispersant | D-1 | 2 | | | | | | | | | 5 | | | 2 | |
| (D) | D-2 | | 5 | | | | | | | | | 10 | | | |
| (parts by weight) | D-3 | | | 10 | | | | | | | | | 15 | | |
| | D-4 | | | | 12 | | | | | | | | | | 12 |
| | D-5 | | | | | 15 | | | | | | | | | |
| | D-6 | | | | | | 20 | | | | | | | | |
| | D-7 | | | | | | | 10 | | | | | | | |
| | D-8 | | | | | | | | 5 | | | | | | |
| | D-9 | | | | | | | | | 15 | | | | | |
| inorganic powder | E-1 | | | | | | | | | | 20 | | | | |
| (E) | E-2 | | | | 2 | | | | | | | 10 | | | 2 |
| (parts by weight) | | | | | | | | | | | | | | | |
| polyolefin wax (F) | F-1 | | | | | 0.5 | | | | | | | 5 | | |
| (parts by weight) | F-2 | | | | | | 1 | | | | | | | | |
| additives (G) | G-1 | | | | | | | | | | 2 | | | | |
| (parts by weight) | G-2 | | | | | | | | | | | 5 | | | |
| Assays | Visibility | ◯ | ◯ | ◯ | ◯ | ◯ | ◯ | ◯ | ◯ | ◯ | ◯ | ◯ | ◯ | ◯ | ◯ |
| | Coating property | ⊚ | ⊚ | ⊚ | ⊚ | ⊚ | ⊚ | ⊚ | ⊚ | ⊚ | ⊚ | ⊚ | ⊚ | ⊚ | ⊚ |
| | Reworkability | ◯ | ◯ | ◯ | ⊚ | ⊚ | ⊚ | Δ | Δ | ◯ | ⊚ | ⊚ | ⊚ | ◯ | ⊚ |
| | Weathering resistance | ◯ | ◯ | ◯ | ◯ | ⊚ | ⊚ | ◯ | ◯ | Δ | ⊚ | ◯ | ◯ | ◯ | ◯ |

TABLE 3
Comparative Examples

| | | | Comparative Examples | | | | | |
|---|---|---|---|---|---|---|---|---|
| Components | | | 1 | 2 | 3 | 4 | 5 | 6 |
| polyurethane | aliphatic | A-1-1 | 100 | | | | | |
| acrylate | polyurethane | A-1-2 | | 100 | | | | |
| oligomer (A) | acrylate oligomer | A-1-3 | | | 100 | | | |
| (parts by weight) | (A-1) | | | | | | | |
| | aromatic | A-2-1 | | | | 100 | | |
| | polyurethane | A-2-2 | | | | | 100 | |
| | acrylate oligomer | A-2-3 | | | | | | 100 |
| | (A-2) | | | | | | | |
| compound (B) | compound (B-1) | B-1-1 | | 3 | | | | |
| having an | represented by | B-1-2 | | | | | 3 | |
| ethylenically | Formula (1) | B-1-3 | | | | | | |
| unsaturated | | B-1-4 | | | | | | |
| group | compound (B-2) | B-2-1 | 5 | | | | | |
| (parts by weight) | represented by | B-2-2 | | | 6 | 5 | | |
| | Formulae (2), (3), | B-2-3 | | | | | | 6 |
| | or (4) | | | | | | | |
| | other compound | B-3-1 | | | | | | |
| | (B-3) having an | B-3-2 | | | | | | |
| | ethylenically | | | | | | | |
| | unsaturated group | | | | | | | |

| | | | | | | | |
|---|---|---|---|---|---|---|---|
| photoinitiator | C-1 | 5 | | 5 | 5 | | 5 |
| (C) | C-2 | | 3 | | | 3 | |
| (parts by weight) | C-3 | 2 | | 3 | | 2 | |
| | C-4 | | 3 | | 2 | | 3 |
| pigment | D-1 | 10 | | | | | |
| dispersant (D) | D-2 | | | | 10 | | |
| (parts by weight) | D-3 | | | | | | |
| | D-4 | | | | | | |
| | D-5 | | | | | | |
| | D-6 | | | | | | |
| inorganic | E-1 | | | | | | |
| powder (E) | E-2 | | | | | | |
| (parts by weight) | | | | | | | |
| polyolefin wax | F-1 | | | | | | |
| (F) | F-2 | | | | | | |
| (parts by weight) | | | | | | | |
| additives (G) | G-1 | | | | | | |
| (parts by weight) | G-2 | | | | | | |
| Assays | Visibility | ◯ | X | X | ◯ | X | X |
| | Coating property | X | ◯ | X | X | ◯ | X |
| | Reworkability | Δ | Δ | Δ | Δ | Δ | Δ |
| | Weathering resistance | ◯ | Δ | ◯ | ◯ | Δ | ◯ |

Table 2 and Table 3:
A-1-1 polyfunctional polyurethane acrylate oligomer CN9013 (Tg=143° C., manufactured by Sartomer Inc.)
A-1-2 aliphatic polyester polyurethane diacrylate oligomer CN962 (Tg=−38° C., manufactured by Sartomer Inc.)
A-1-3 aliphatic polyurethane acrylate oligomer CN2920 (Tg=59° C., manufactured by Sartomer Inc.)
A-2-1 low-viscosity aromatic polyurethane oligomer CN999 (Tg=97° C., manufactured by Sartomer Inc.)
A-2-2 aromatic polyether polyurethane diacrylate oligomer CN978 (Tg=−40° C., manufactured by Sartomer Inc.)
A-2-3 aromatic polyurethane triacrylate oligomer CN2902 (Tg=25° C., manufactured by Sartomer Inc.)
B-1-1 acrylic acid 2-(2-vinyloxyethoxy)ethyl
B-1-2 acrylic acid 2-vinyloxyethyl
B-1-3 acrylic acid 3-vinyloxypropyl
B-1-4 acrylic acid 2-vinyloxypropyl
B-2-1 compound represented by (a)
B-2-2 Miramer M4004 (manufactured by TOYO KAGAKU, INC.)
B-2-3 M-460 (manufactured by Toa Gosei Co., Ltd.)
B-3-1 TO-1382 (manufactured by Toa Gosei Co., Ltd.)
B-3-2 KAYARAD DPCA-20 (manufactured by Nippon Kayaku Co., Ltd.)
C-1 2-methyl-1-(4-methylthiophenyl)-2-morpholino-1-propanone
C-2 2-benzyl-2-N,N-dimethylamino-1-(4-morpholinophenyl)-1-butanone
C-3 4,4′-bis(diethylamino)benzophenone
C-4 2,2′-bis(2,4-dichlorophenyl)-4,4′,5,5′-tetraphenyl biimidazole
E-1 aluminum hydroxide
E-2 magnesium hydroxide
F-1 CERAFLOUR 970 (melting point: 160° C., manufactured by BYK)
F-2 AC-316A (melting point: 140° C., manufactured by Allied Signal)
G-1 silicone oil
G-2 manganese naphthenate

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. A photo-curing and strippable adhesive composition comprising:
a polyurethane acrylate oligomer (A);
a compound (B) having an ethylenically unsaturated group;
a photoinitiator (C); and
a pigment dispersant (D);
wherein:
the compound (B) having the ethylenically unsaturated group comprises a compound (B-1) represented by Formula (1), 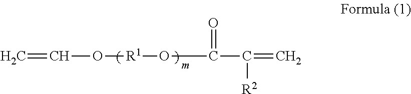
in Formula (1), R¹ represents a C₂ to C₈ divalent hydrocarbon group; R² represents hydrogen, or a methyl group; m represents an integer from 1 to 20; when m is an integer more than 2, a plurality of R¹ is the same or different.

2. The photo-curing and strippable adhesive composition according to claim 1, wherein the pigment dispersant (D) comprises an organic pigment, a polymerizable monomer, and an adhesive resin.

3. The photo-curing and strippable adhesive composition according to claim 2, wherein the organic pigment comprises triphenylmethane, copper phthalocyanine, non-metallic phthalocyanine, indanthrone or indigo.

4. The photo-curing and strippable adhesive composition according to claim 2, wherein the polymerizable monomer comprises a cyclic monofunctional monomer and/or a bi-functional monomer.

5. The photo-curing and strippable adhesive composition according to claim 2, wherein the adhesive resin comprises polyvinyl chloride, poly(methyl)acrylate, epoxy resin, polyurethane resin, cellulose derivatives, polyvinyl chloride-vinyl acetate copolymer, polyamide resin, polyvinyl acetal resin, diallyl phthalate resin, butandiene-acrylonitrile copolymer, acrylic acid resin, styrene-acrylic acid resin, styrene-maleic acid resin, abietic resin, rosin ester resin, ethylene-vinyl acetate resin, petroleum resin, indene resin, terpene phenolic resin, phenolic resin, melamine resin, urea resin, cellulose resin, chloride vinyl acetate resin, xylene resin, alkyd resin, aliphatic hydrocarbon resin, butyral resin, silicone resin, maleic acid resin, or fumaric acid resin.

6. The photo-curing and strippable adhesive composition according to claim 2, wherein based on 100 parts by weight of the used amount of the pigment dispersant (D), the used amount of the organic pigment is from 5 to 50 parts by weight; the used amount of the polymerizable monomer is from 2 to 20 parts by weight; the used amount of the adhesive resin is from 30 to 93 parts by weight.

7. The photo-curing and strippable adhesive composition according to claim 1, wherein based on 100 parts by weight of the used amount of the polyurethane acrylate oligomer (A), the used amount of the compound (B) having the ethylenically unsaturated group is from 1 to 20 parts by weight; the used amount of the photoinitiator (C) is from 1 to 10 parts by weight; the used amount of the pigment dispersant (D) is from 2 to 20 parts by weight.

8. The photo-curing and strippable adhesive composition according to claim 1, wherein based on 100 parts by weight of the used amount of the polyurethane acrylate oligomer (A), the used amount of the compound (B-1) is from 0.1 to 5 parts by weight.

9. The photo-curing and strippable adhesive composition according to claim 1, wherein the compound (B) having the ethylenically unsaturated group further comprises a compound (B-2) selected from the group consisting of Formulae (2), (3) and (4), 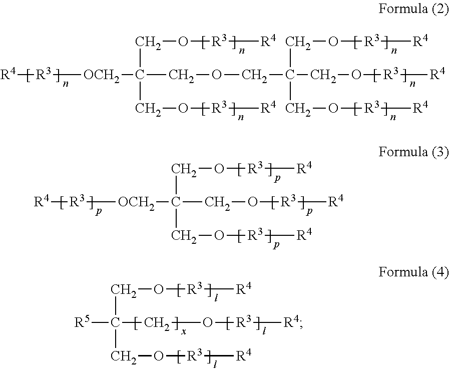
in Formulae (2) to (4),
R³ independently represents —(CH₂CH₂O)— or —(CH₂CH(CH₃)O)—;
R⁴ independently represents an acryloyl group, a methacryloyl group or hydrogen;
R⁵ independently represents hydrogen, a C₁ to C₆ alkyl group or an aryl group;
n independently represents an integer from 0 to 6, and a total number of n is 3 to 24;
p independently represents an integer from 0 to 6, and a total number of p is 2 to 16;
l independently represents an integer of 0 to 10, and a total number of l is 3 to 30; and
x represents an integer from 0 to 3; and
in Formula (2), a total number of the acryloyl group and methacryloyl group is 5 or 6;
in Formula (3), a total number of the acryloyl group and methacryloyl group is 3 or 4; and
in Formula (4), a total number of the acryloyl group and methacryloyl group is 3.

10. The photo-curing and strippable adhesive composition according to claim 9, wherein based on 100 parts by weight of the used amount of the polyurethane acrylate oligomer (A), the used amount of the compound (B-2) is from 0.5 to 10 parts by weight.

11. The photo-curing and strippable adhesive composition according to claim 1, wherein the photo-curing and strippable adhesive composition further comprises an inorganic powder (E).

12. The photo-curing and strippable adhesive composition according to claim 11, wherein based on 100 parts by weight of the used amount of the polyurethane acrylate oligomer (A), the used amount of the inorganic powder (E) is from 2 to 20 parts by weight.

13. The photo-curing and strippable adhesive composition according to claim 1, wherein the photo-curing and strippable adhesive composition further comprises a polyolefin wax (F).

14. The photo-curing and strippable adhesive composition according to claim 13, wherein based on 100 parts by weight of the used amount of the polyurethane acrylate oligomer (A), the used amount of the polyolefin wax (F) is from 0.5 to 5 parts by weight.

15. A method for manufacturing a strippable material comprising coating the photo-curing and strippable adhesive composition according to claim 1 on a substrate.

16. The method according to claim 15, wherein the substrate is an electronic component.

17. A strippable material, which is obtained by the method according to claim 15.

18. The strippable material according to claim 17, wherein the substrate is an electronic component.

19. An electronic device, comprising the strippable material according to claim 17.

20. A method for manufacturing an electronic device, wherein the electronic device comprising a strippable material, wherein the strippable material is provided by the method according to claim 15.
